(19) United States
(12) Patent Application Publication
(10) Pub. No.: US 2026/0203064 A1
(43) Pub. Date: Jul. 16, 2026

(54) NON-FLUSHING VECTOR MICRO-OPERATIONS WITH VSET

(71) Applicant: Akeana, Inc, Santa Clara, CA (US)

(72) Inventors: Abhijit Sil, Dublin, CA (US); Ricardo Ramirez, Sunnyvale, CA (US)

(73) Assignee: Akeana, Inc., Santa Clara, CA (US)

(21) Appl. No.: 19/448,244

(22) Filed: Jan. 14, 2026

Related U.S. Application Data
(60) Provisional application No. 63/745,432, filed on Jan. 15, 2025.
(60) Provisional application No. 63/764,198, filed on Feb. 27, 2025.
(60) Provisional application No. 63/765,094, filed on Feb. 28, 2025.
(60) Provisional application No. 63/777,814, filed on Mar. 26, 2025.
(60) Provisional application No. 63/795,829, filed on Apr. 28, 2025.
(60) Provisional application No. 63/797,195, filed on Apr. 30, 2025.
(60) Provisional application No. 63/803,977, filed on May 12, 2025.
(60) Provisional application No. 63/831,282, filed on Jun. 27, 2025.
(60) Provisional application No. 63/844,802, filed on Jul. 16, 2025.
(60) Provisional application No. 63/854,877, filed on Jul. 31, 2025.
(60) Provisional application No. 63/870,916, filed on Aug. 27, 2025.
(60) Provisional application No. 63/899,591, filed on Oct. 15, 2025.
(60) Provisional application No. 63/914,824, filed on Nov. 10, 2025.
(60) Provisional application No. 63/941,793, filed on Dec. 16, 2025.

(51) Int. Cl. G06F 9/30; G06F 9/38

(52) U.S. Cl. CPC G06F 9/3016; G06F 9/30036; G06F 9/30058; G06F 9/3861

(57) ABSTRACT

A processor core is accessed. The processor core is configured to execute vector instructions and micro-operations. The vector instructions are converted to micro-operations by a micro-operation sequencer. A VSET instruction includes immediate values that specify an architectural state for vector processing. Changes in architectural state due to VSET instructions are saved as a vector state in a decode unit of the processor core. The saved architectural state serves to reduce the number of instructions that need to get flushed in cases of branch misprediction recovery. A conditional branch instruction is dispatched by the processor core. The dispatching includes storing, by the decode unit, the vector state within the decode unit. The conditional branch instruction is mispredicted. The mispredicting causes one or more erroneous instructions to be executed. The one or more erroneous instructions include erroneously changing the vector state within the decode unit.

### RELATED APPLICATIONS

This application claims the benefit of U.S. provisional patent applications “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, “AI Compute Clusters With Noncoherent Shared SRAM” Ser. No. 63/854,877, filed Jul. 31, 2025, “In-Order Multithreading With Pipeline Flush And Instruction Replay” Ser. No. 63/870,916, filed Aug. 27, 2025, “Invalidating Snoop Avoidance With Multiple Atomic Loops” Ser. No. 63/899,591, filed Oct. 15, 2025, “Matrix Multiply Acceleration Based On A Static Partitioning History Table” Ser. No. 63/914,824, filed Nov. 10, 2025, and “Hierarchical Performance-Based Scheduler For Data Center Workloads” Ser. No. 63/941,793, filed Dec. 16, 2025.

Each of the foregoing applications is hereby incorporated by reference in its entirety.

### FIELD OF ART

This application relates generally to instruction execution and more particularly to non-flushing vector micro-operations with VSET.

### BACKGROUND

Vectors are fundamental in mathematics because they provide a way to represent and manipulate quantities that have both magnitude and direction. Their versatility makes them essential across various fields and applications from physics to computer science, engineering, and beyond. Vectors can be used to represent physical quantities. Many real-world phenomena, such as velocity, force, and acceleration, are naturally represented as vectors. Vectors enable precise modeling of these quantities in a multi-dimensional space. Vectors can also be used for geometry and spatial analysis. Vectors are useful for describing points, lines, and planes in space. Operations such as dot products and cross products allow for computations involving angles, distances, and areas. Moreover, vectors are the building blocks of vector spaces, useful in linear algebra. They can be used to solve systems of linear equations, optimize processes, and perform transformations. Furthermore, in data science and machine learning, data points are often represented as vectors in high-dimensional spaces. Techniques such as clustering, classification, and regression rely heavily on vector operations.

Vectors are a cornerstone of machine learning, serving as a primary way to represent data and perform computations. Their mathematical properties and compatibility with algorithms make them essential for solving complex problems across a wide range of applications. Vectors can be used for data representation. Each data point, whether it is a numerical measurement, a pixel in an image, or a word in a sentence, can be represented as a vector. For example, in image processing, pixel intensity values are stored as vectors, and in natural language processing (NLP), words can be represented as vectors in embeddings such as Word2Vec or GloVe. Features extracted from raw data are organized into vectors to form the basis of a feature space. Machine learning algorithms can operate in these feature spaces, where data is analyzed and patterns are learned. Moreover, vectors enable the calculation of distances (e.g., Euclidean distance, cosine similarity) to measure how similar or dissimilar data points are. This is vital for clustering (e.g., k-means), recommendation systems, and nearest-neighbor algorithms. In models such as neural networks, vectors represent weights, biases, and gradients. Optimization algorithms such as stochastic gradient descent (SGD) use vector operations to minimize loss functions and train models. Additionally, many machine learning operations, such as scaling, rotation, and projection, involve linear transformations of vectors. These transformations are key to methods such as principal component analysis (PCA) for dimensionality reduction.

Another key area where vectors have utility is in computer vision applications. In computer vision applications, vectors can enable the representation, processing, and analysis of visual data. They provide a mathematical framework to manipulate and interpret images, videos, and 3D structures, facilitating tasks such as object detection, image recognition, and scene understanding. An image can be represented as a vector by flattening its pixel values into a one-dimensional array. Algorithms such as SIFT (Scale-Invariant Feature Transform) and HOG (Histogram of Oriented Gradients) can produce feature vectors to describe image regions compactly. Furthermore, in 3D computer vision, vectors represent points in 3D space, describing object shapes, camera positions, and depth maps.

Thus, vector-based mathematics can support a vast range of computer applications by enabling efficient manipulation of data, space, and physics. In applications including gaming, artificial intelligence, robotics, and simulations, vectors offer a way to represent and solve complex problems in multi-dimensional spaces and enable many other applications.

### SUMMARY

Efficient and powerful processors are at the heart of modern computing, enabling devices and systems to handle increasingly complex tasks while meeting demands for speed, energy efficiency, and scalability. As applications become more advanced, from artificial intelligence to real-time analytics, the role of processors has never been more critical. Modern applications such as AI, machine learning, and big data analytics can require immense computational power. Applications such as autonomous vehicles, gaming, and financial trading systems rely on real-time decision making. Efficient processors can ensure low latency and high throughput, enabling systems to respond quickly to inputs. Typical methods of enhancing processor performance include speculative execution and pipelining. Splitting complex instructions into less complex micro-operations, which are easier to execute within an execution pipeline, can also increase performance. However, complications can arise when states, such as a vector state, are updated by an instruction. An example of updating a vector state within the RISC-V architecture is the vector set (VSET) instruction. Further complications arise when an instruction, such as the VSET instruction, is executed speculatively. If a branch is mispredicted, the processor may be required to flush instructions in the pipeline, which can include the VSET instruction. Thus, the processor must reset the state to the value prior to when the VSET instruction was executed.

Techniques for non-flushing vector micro-operations with VSET are disclosed. A processor core is accessed. The processor core is configured to execute vector instructions and micro-operations. The vector instructions are converted to micro-operations by a micro-operation sequencer. A VSET instruction includes immediate values that specify an architectural state for vector processing. Changes in architectural state due to VSET instructions are saved as a vector state in a decode unit of the processor core. The saved architectural state serves to reduce the number of instructions that need to get flushed in cases of branch misprediction recovery.

Disclosed embodiments provide a computer-implemented method for instruction execution comprising: accessing a processor core, wherein the processor core is configured to execute vector instructions and micro-operations; decoding, by a decode unit, a vector set (VSET) instruction, wherein the VSET instruction includes an immediate value, and wherein the VSET instruction updates a vector state within the decode unit; further decoding, by the decode unit, a vector instruction; and replacing, by the decode unit, the vector instruction with one or more vector micro-operations, wherein the replacing is based on the immediate value that was included in the VSET instruction. Some embodiments comprise dispatching, by the processor core, a conditional branch instruction. In embodiments, the dispatching includes storing, by the decode unit, the vector state within the decode unit. Some embodiments comprise mispredicting the conditional branch instruction. In embodiments, the mispredicting causes one or more erroneous instructions to be executed. In embodiments, the one or more erroneous instructions include erroneously changing the vector state within the decode unit.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for non-flushing vector micro-operations with VSET.

FIG. 2 is a flow diagram for non-flushing vector micro-operations with a mispredicted branch.

FIG. 3 is a first infographic for non-flushing vector micro-operations with VSET.

FIG. 4 is a second infographic for non-flushing vector micro-operations with VSET and a conditional branch.

FIG. 5 is a block diagram of a multicore processor.

FIG. 6 is a block diagram of a pipeline.

FIG. 7 is a first code example of non-flushing vector micro-operations with VSET.

FIG. 8 is a second code example of non-flushing vector micro-operations with a conditional branch.

FIG. 9 is a design flow for semiconductor logic generation.

FIG. 10 is a system diagram for non-flushing vector micro-operations with VSET.

### DETAILED DESCRIPTION

Today's processors must commonly run workloads that require high performance. A number of techniques can be implemented to achieve the necessary performance to adequately execute applications such as modeling, artificial intelligence models, and so on. One such example is pipelining execution units within a processor. By separating the execution of instructions into multiple pipeline stages, each stage can be optimized for a specific task, resulting in faster micro-operation processing. Use of a pipeline can reduce the time it takes to execute a series of micro-operations when providing the micro-operations to the pipeline. This technique enables the processor to initiate processing of a next operation before the previous operation has completed, leading to faster overall program execution. Speculative execution can be another technique used in modern processors to improve performance by predicting the outcome of conditional branches and executing instructions ahead of time. While this approach can significantly enhance efficiency when predictions are correct, it has notable disadvantages when branch predictions are incorrect. For example, when a branch prediction is proven to be incorrect (which can occur many cycles after the original branch instruction), the processor can discard the results of incorrectly speculatively executed instructions. These wasted computations do not contribute to program progress, reducing overall efficiency. In response to a branch misprediction, the processor pipeline is cleared (flushed), and correct instructions from the actual branch are re-fetched and re-executed. This incurs a delay known as a pipeline stall, degrading performance. Recovering from a mispredicted branch requires re-executing the correct path, increasing latency for completing tasks.

Another common technique of increasing performance is through the use of vector instructions. Extensions such as vector operation extensions can be enabled for a processor architecture such as RISC-V™. Vector registers in a processor can be designed to efficiently handle operations on multiple data elements simultaneously. These registers enable a single instruction to operate on multiple data elements, which is particularly beneficial for tasks that involve large datasets and/or parallel processing. The vector registers can support addition and/or subtraction of corresponding elements of two vectors, producing a new vector as the result. Additionally, other operations, including, but not limited to, vector multiplication, vector division, vector dot product, vector shifts, and/or other operations, can be supported with vector registers. Furthermore, the vector operations can include vector load and vector store operations, to enable loading data from memory into the register or storing data from the register back to memory. While vector instructions can increase performance, they can also be complex to implement in a shallow pipeline processor, such as a reduced instruction set computer (RISC) processor. To maintain efficient pipeline usage of such implementations, vector operations can be split into a series of micro-operations, which can be more easily executed by the pipeline. The efficient operation of pipelines allows for the concurrent execution of multiple micro-operations, yielding a higher instruction throughput.

Complications can arise when states, such as a vector state, are updated by an instruction. An example of updating a vector state within the RISC-V^{TM} architecture is the VSET instruction. The VSET instruction can update the state based on a set of registers, immediate values, and so on. When splitting vector operations into micro-operations, a decode unit must know the vector state since the state can affect the number and type of micro-operations that are generated. Further complications arise when an instruction, such as the VSET instruction, is executed speculatively within a processor pipeline. If a branch is mispredicted, the processor may be required to flush instructions in the pipeline, which can include the VSET instruction, resulting in performance loss. Further, the processor must reset the state to the value prior to when the VSET instruction was executed, thus potentially causing the re-execution of a number of instructions which were executed correctly (e.g., that were executed before the branch was encountered). These issues can reduce the hard-won performance gains from pipelining, vector operations, and speculative execution. Disclosed embodiments mitigate the aforementioned problems with non-flushing vector micro-operations with VSET. A current architectural state is saved each time a VSET instruction is encountered that includes immediate values as input parameters, and each time a branch is taken, such as for speculative execution. In this way, a correct vector state can be quickly accessed without the need for flushing and re-executing instructions.

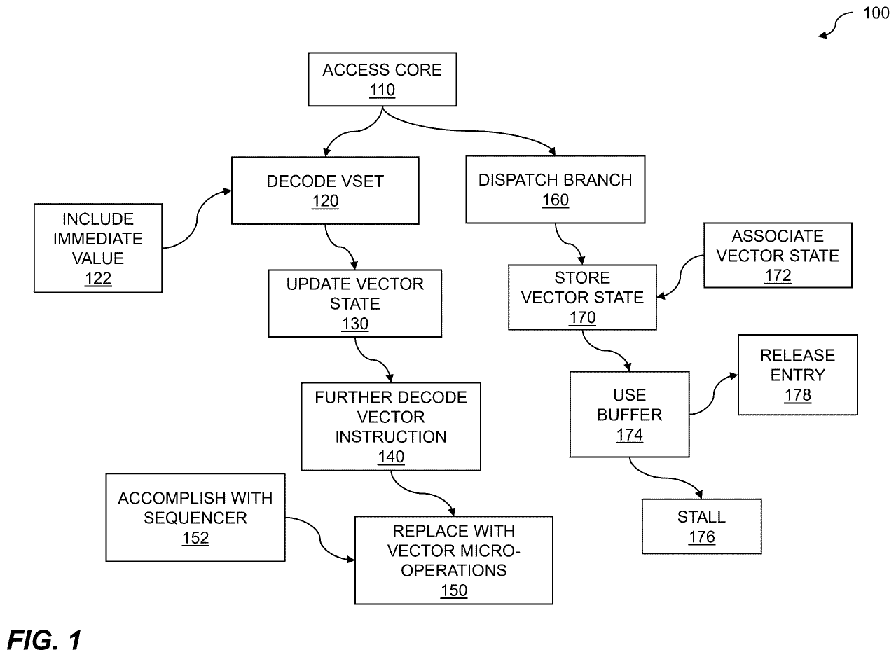

FIG. 1 is a flow diagram for non-flushing vector micro-operations with VSET. The flow 100 includes accessing a processor core 110. The processor core can be included on a multi-processor chip, an application specific integrated circuit (ASIC), a system-on-a-chip (SOC), and so on. The processor core can include a RISC-V^{TM} core, MIPS^{TM} core, ARM^{TM} core, and so on. The processor core can be coupled to a memory hierarchy. The memory hierarchy can include multiple cache levels, memory, and/or other storage technologies. The processor core can execute instructions that are part of an instruction set architecture (ISA) such as X86, ARM^{TM}, and so on. The memory hierarchy can include L1, L2, L3, etc. caches. The memory hierarchy can include memory such as DRAM, SDRAM, and so on. The memory hierarchy can be coherent or non-coherent. The processor core is configured to execute vector instructions, scalar instructions, and micro-operations. The micro-operations can comprise a series of less complex instructions that can take the place of a single, more complex instruction. A micro-operation sequencer can be used to generate micro-operations for vector instructions, scalar instructions, floating-point instructions, and so on.

The flow 100 includes decoding, by a decode unit, a VSET instruction 120. The VSET instruction in a RISC-V™ processor can be part of a RISC-V™ Vector Extension (RVV) that configures a vector processing unit which can be included within the processor core. This instruction can be used to set various parameters of the vector architectural state, enabling efficient execution of vectorized computations. The VSET instruction can be used to configure a vector length (VL), which can determine how many elements of a vector register are active during computation. Another parameter within the architectural state of the vector processing unit is the Standard Element Width (SEW). The SEW can specify the size of each element in a vector (e.g., 8, 16, 32, or 64 bits). The SEW can enable operations on different data types, such as integers, floating-point numbers, and/or smaller subfields. Another parameter which can be set by VSET is the vector length multiplier (VMUL). The number of destination registers can be determined by a combination of VMUL, SEW, an effective element width (EEW, which can define a vector element width within an instruction opcode), and so on. A combination of VLM, EEW, and SEW can define one or more destination registers that are operated on by a single vector instruction. Use of the VSET function can allow fine-grained control over vector processing, ensuring that the hardware operates efficiently for a given task. For example, smaller SEW and VL values can conserve memory bandwidth and computation resources for operations on smaller datasets. Additionally, VSET can enable a single processor to adapt to varied data sizes and types, such as switching between 32-bit floating-point computations (for example, for machine learning tasks) and 8-bit integer data (for example, for image processing). Adjusting VSET can have additional applications, such as handling loop boundaries. By setting VL dynamically, the VSET instruction can adapt to the remainder elements in a loop iteration that do not fit into a full vector register. The dynamic VL adjustments can eliminate the need for special scalar code to handle the “leftover” data, streamlining computation and improving processor performance. Dynamically adapting parameters such as vector length and element width through a VSET instruction performance can be optimized across a range of applications, making it a critical component of modern RISC-V architecture.

The VSET instruction can update a vector state directly with an immediate value, indirectly by a set of registers, using a combination of both, or in other ways. When registers are used to set a vector state, a micro-operation sequencer within the decode unit can produce unreliable results. The micro-operation sequencer relies on the vector state (such as VL, VMUL, and so on) to produce the correct type and number of vector micro-operations which can then be executed by a pipeline within the processor. The register files are not normally accessible by the decode unit. Therefore, any VSET value that is set with register values will not be known to the decode unit and any micro-operations will likely be incorrect. In this case, a flush will need to occur when the VSET instruction commits and the VSET value will need to be reset to the previous value. If no change has taken place in the VSET value, a flush can be avoided. The VSET instruction includes an immediate value 122. One or more immediate values can be included. The immediate values can be included as operands in a VSET instruction. An immediate value can be read by the decode unit and therefore can be used to generate correct micro-operations. The VSET instruction updates a vector state 130 within the decode unit. The state can allow the micro-operation sequencer to produce correct micro-operations that can be executed and committed by the processor. The vector state can include parameters described above such as VL, VMUL, SEW, and so on.

The flow 100 includes further decoding a vector instruction 140. The vector instruction can be decoded before, during, or after the updating of the vector state. The vector instruction can include arithmetic operations such as vector addition (VADD), vector subtraction (VSUB), vector multiplication (VMUL), and/or vector division (VDIV). The vector instruction can include logical operations such as bitwise AND (VAND), bitwise OR (VOR), bitwise XOR (VXOR), and bitwise NOT (VNOT). The vector instructions can include comparison operations such as VMSLT, VMSLE, and/or VMSEQ for setting a bit based on a comparison result. The vector instruction can include data movement operations such as vector load (VL) and/or vector store (VS). Other vector instructions are possible in exemplary implementations.

The flow 100 includes replacing, by the decode unit, the vector instruction with one or more vector micro-operations 150. The micro-operations can include a series of less complex instructions that can take the place of a single, more complex instruction. In embodiments, the replacing is accomplished by a micro-operation sequencer 152. The micro-operation sequencer can be used for vector instructions, scalar instructions, floating-point instructions, and so on. The use of micro-operations, along with dedicated queues, can reduce bottlenecks such as pipeline stalls, thereby improving processor performance. In exemplary implementations, the micro-operation sequencer can be implemented as a finite state machine, which takes inputs that can include a type register, a source register, a destination register, and/or other operands. The micro-operation sequencer logic can implement architectural instructions by breaking the instruction into individual micro-operations. The replacing is based on the immediate value that was included in the VSET instruction. As described above, the decode unit can read an immediate value associated with a VSET instruction. This immediate value can be used to set important values that control the vector state such as VL, VMUL, VSEW, etc. These values can be used by the micro-operation sequencer to generate correct micro-operations.

The flow 100 includes dispatching, by the processor core, a conditional branch instruction 160, wherein the dispatching includes storing, by the decode unit, the vector state within the decode unit. Conditional branch instructions in a processor can control the flow of execution by altering the program counter (PC) based on certain conditions. They can be crucial for implementing common procedures, such as decision making, loops, and function calls within a program. Conditional branch instructions can require the processor to determine a conditional expression in order to select the next instruction to execute. Once resolved, if the branch is taken, the PC can be updated with the target address; otherwise, program execution can continue sequentially. Conditional branch instructions can also introduce latency. To mitigate the latency while the branch is being resolved, a branch predictor can be used to assume an outcome of the conditional branch. The branch prediction can utilize static prediction, where a fixed behavior is assumed (e.g., always predicted as “not taken”). The branch prediction can use dynamic prediction, based on historical data (such as 1-bit, 2-bit, and so on), to make predictions that may have improved accuracy over static prediction. Speculative execution can be used to exploit correct branch prediction. In exemplary implementations, a processor core may execute instructions for a predicted branch outcome, but before the actual branch outcome is known. If the prediction turns out to be correct, the speculatively executed instructions are retained. If the prediction turns out to be incorrect, the speculatively executed instructions are flushed, and a branch misprediction recovery process is performed, which includes executing the instructions corresponding to the correct branch path.

The dispatching includes storing, by the decode unit, the vector state 170 within the decode unit. When the vector state changes due to speculative execution, it can complicate the branch misprediction recovery process. By storing the vector architectural state for each branch, it is possible to restore the vector state to its last known correct state, thereby minimizing the number of instructions that need to be flushed and/or re-executed as part of a branch misprediction recovery process. The storing includes associating the vector state 172 with the conditional branch instruction. By associating the vector state with a branch instruction, when speculatively executed instructions need to be flushed, the correct vector state can be determined without necessarily having to flush instructions back to the last non-speculative VSET instruction. In this way, subsequent instructions following the last non-speculative VSET instruction may not need to be flushed, thereby improving overall processor performance. The associating is accomplished with an entry within a buffer 174. In exemplary implementations, associations between a branch and a vector state can be stored in a buffer. The buffer can include a FIFO, LIFO, circular buffer, content-addressable memory (CAM), and/or other suitable type of buffer. In exemplary implementations, the buffer can include a branch identifier (branch ID), and a corresponding vector state (vector architectural state). There can be multiple levels of speculative execution based on branch prediction. Each predicted branch can correspond to an entry in the buffer. Thus, in embodiments, the associating is accomplished with an entry within a buffer.

The flow 100 includes stalling 176, by the decode unit, wherein the buffer is full. In the event that a branch instruction is encountered when the buffer is full, the processor can stall. The stall gives an opportunity for space to become available in the buffer, due to resolution of branch instructions. The flow 100 includes releasing the entry 178 within the buffer. The releasing frees up an entry in the buffer, to enable associating vector states with future branch instructions. In embodiments, the releasing is based on a correct branch prediction. When the branch is executed in the processor pipeline, it may be determined that the branch was correctly predicted. In this case, there is no reason to keep the vector state associated with the conditional branch since no instructions will need to be flushed and the vector state will not need to be rolled back to a previous state. In other embodiments, the releasing is based on rolling back the vector state to the vector state that was stored. When the conditional branch is mispredicted, as explained above, instructions will likely need to be flushed from the pipeline. If any instruction changed the vector state (such as another VSET instruction), the vector state will also need to be rolled back to the state it was in when the conditional branch was encountered. This can be done with the state that was saved. Once the vector state has been rolled back, there is no need to maintain the state and the data can be released from the buffer, opening space for a vector state associated with another branch instruction.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

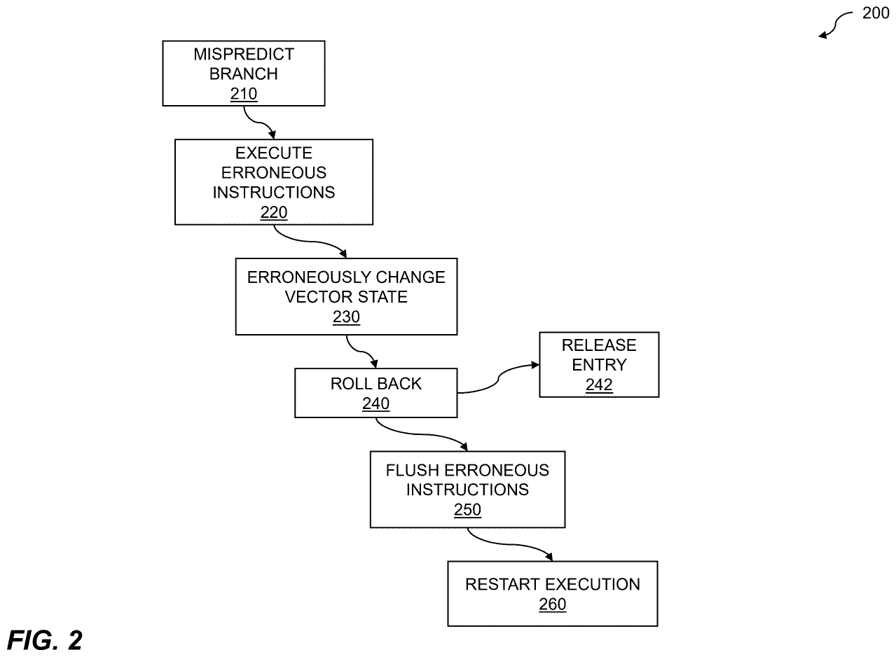

FIG. 2 is a flow diagram for non-flushing vector micro-operations with a mispredicted branch. As described above, program execution can include a conditional branch instruction which can alter the flow of execution based on certain conditions. Conditional branch instructions can require the processor to determine a conditional expression in order to select the next instruction to execute. Once resolved, if the branch is taken, the PC can be updated with the target address; otherwise, program execution can continue sequentially. Conditional branch instructions can also introduce latency. To mitigate the latency while the branch is being resolved, a branch predictor can be used to assume an outcome of the conditional branch. The branch prediction can utilize static prediction, where a fixed behavior is assumed (e.g., always predicting “not taken”). The branch prediction can use dynamic prediction, based on historical data (such as 1-bit, 2-bit, and so on), to make predictions that may have improved accuracy over static prediction. Speculative execution can be used to exploit correct branch prediction. In exemplary implementations, a processor core may execute instructions for a predicted branch outcome, but before the actual branch outcome is known. If the prediction turns out to be correct, the speculatively executed instructions are retained. If the prediction turns out to be incorrect, the speculatively executed instructions are flushed, and a branch misprediction recovery process is performed, which includes executing the instructions corresponding to the correct branch path.

Embodiments include dispatching, by the processor core, a conditional branch instruction, wherein the dispatching includes storing, by the decode unit, the vector state within the decode unit. When the vector state changes due to speculative execution, it can complicate the branch misprediction recovery process. By storing the vector architectural state for each branch, it is possible to restore the vector state to its last known correct state, thereby minimizing the number of instructions that need to be flushed and/or re-executed as part of a branch misprediction recovery process.

The flow 200 includes mispredicting the conditional branch instruction 210, wherein the mispredicting causes one or more erroneous instructions to be executed, wherein the one or more erroneous instructions include erroneously changing the vector state within the decode unit. As described above, conditional branches can be mispredicted. That is, to avoid the latency penalty that can be associated with resolving a branch's target address, a branch prediction mechanism such as static branch prediction, dynamic branch prediction, saturating counter branch prediction, two-level branch prediction, and so on, can be used. A branch misprediction can occur when a processor's branch predictor incorrectly guesses the direction of a conditional branch instruction (such as a conditional jump). Branch prediction algorithms generally do not provide 100% accuracy for all types of code run by the processor code.

The mispredicting causes one or more erroneous instructions to be executed 220. A branch misprediction can cause the processor to speculatively execute the wrong set of instructions, which then need to be flushed from the processor pipeline(s). The erroneous instructions can include one or more erroneous vector micro-operations. This can be determined after the conditional branch is resolved and the target address is compared to the address that the branch prediction algorithm predicted. If they do not match, then instructions that were executed were in error and must be flushed. Correct instructions can then be fetched from the memory hierarchy and executed. The time lost in executing incorrect instructions and fetching new instructions can be associated with a branch misprediction penalty. This penalty can be quite large for processors with long pipelines.

The one or more erroneous instructions include erroneously changing the vector state 230 within the decode unit. The erroneous instructions that were executed due to branch misprediction can include any type of instruction, including instructions that update a processor state such as the VSET instruction. Thus, it is possible that the vector state within the decode unit, which can be updated by a VSET instruction, can erroneously set the vector state within the decode unit. In embodiments, the erroneously changing the vector state is based on a second VSET instruction, wherein the second VSET instruction is based on the mispredicting. A VSET instruction can be decoded prior to a conditional branch that can update the vector state within the decode unit. The vector state can be saved. Later, a conditional branch can be decoded and mispredicted, causing erroneous instructions to execute. The erroneous instructions can include a second VSET instruction which can update the vector state of the decode unit erroneously. This can lead to other issues as the decode unit can include a micro-operation sequencer which generates one or more vector micro-operations in response to decoding a vector instruction. If the vector state in the decode unit is incorrect, the vector micro-operations can also be incorrect since the micro-operation sequencer can rely on the vector state to determine details such as which vector micro-operations are generated, how many are generated, the target addresses for the vector micro-operations, and so on.

The flow 200 includes rolling back 240 the vector state to the vector state that was stored. Recall that the vector state can be stored when a conditional branch instruction is executed. The rolling back can include accessing the vector state that was saved and associated with the conditional branch that was mispredicted. The rolling back can efficiently restore the decode unit's vector state to a known good state. That is, by associating the vector state with a branch instruction, when speculatively executed instructions need to be flushed, the correct vector state can be accessed in the buffer without necessarily having to flush instructions all the way back to the last non-speculative VSET instruction. In this way, subsequent instructions following the last non-speculative VSET instruction may not need to be flushed, thereby improving overall processor performance. The vector state can be stored in a buffer such as a CAM, a FIFO, and so on. The vector state can be stored in an entry in the buffer. Embodiments include releasing the entry 242 within the buffer. In further embodiments, the releasing is based on rolling back the vector state to the vector state that was stored. Once the vector state within the decode unit is rolled back to the correct state (prior to the branch misprediction), there is no longer a need to store the vector state information in the buffer. Thus, the entry can be released, and a new vector state can be saved the next time a branch is encountered.

The flow 200 includes flushing the one or more erroneous instructions 250. When a branch misprediction occurs, a branch misprediction recovery process can be executed. The branch misprediction recovery process can include detection that a conditional branch prediction was incorrect. The detection of an incorrect branch can include comparing the actual outcome of the branch (whether it was taken or not) with the predicted outcome. In exemplary implementations, this comparison can be performed in a branch execution unit of the processor. Then, instructions that have been speculatively executed (e.g., based on the wrong branch prediction) are flushed from the pipeline.

The flow 200 includes restarting execution 260, wherein the restarting is based on the conditional branch instruction that was mispredicted. After the misprediction becomes known and incorrect instructions are flushed from the processor pipeline(s), the processor can restore the state to the point before the mispredicted branch. With exemplary implementations, the restoring can include restoring the last known good vector architectural state. Then, the correct instructions can be fetched based on the correct branch target address, and execution can restart with instructions along the correct code path. This recovery process ensures that the execution gets back on track, albeit with some performance penalty (called a branch mispredict penalty) due to the flushing and re-execution steps. Disclosed implementations serve to reduce the performance penalty by reducing the number of instructions that need to be flushed and/or re-executed as a result of a branch misprediction event.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

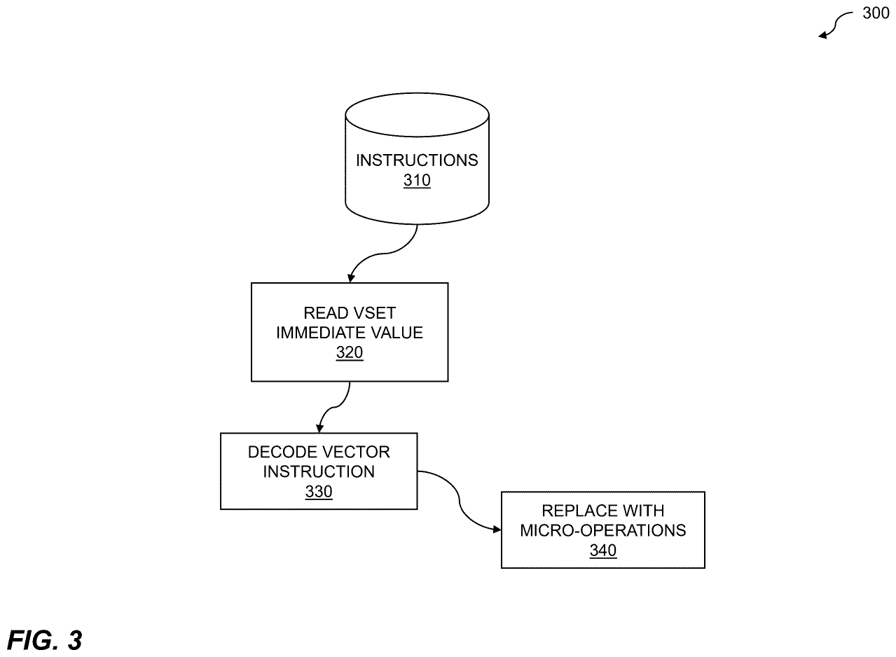

FIG. 3 is a first infographic for non-flushing vector micro-operations with VSET. The infographic 300 includes instructions 310. The instructions can include a variety of instructions, including arithmetic instructions, memory management instructions, comparison instructions, branching instructions, scalar instructions, vector instructions, and so on. The instructions can include instructions that are replaced with multiple micro-operations for execution. Embodiments include accessing a processor core, wherein the processor core is configured to execute vector instructions and micro-operations.

The infographic 300 includes reading a VSET immediate value 320. The instructions can include VSET instructions that use immediate values for operands. Immediate values can reduce the need for extra memory accesses, which can be slower than accessing data directly from operands within the instruction itself. Moreover, the decode unit may not have access to general-purpose register (GPR) register files. Accordingly, for VSET instructions, using immediate values allows the decode unit to access the vector architectural state quickly and completely, thereby enabling the vector architectural state to be saved whenever it changes, and/or whenever a branch path is speculatively executed. Embodiments include decoding, by a decode unit, a vector set (VSET) instruction, wherein the VSET instruction includes an immediate value, and wherein the VSET instruction updates a vector state within the decode unit. The infographic 300 includes decoding a vector instruction 330. The vector instruction can include arithmetic operations, logical operations, comparison operations, data movement operations, and/or other suitable types of operations. Embodiments include decoding, by a decode unit, a vector set (VSET) instruction, wherein the VSET instruction includes an immediate value, and wherein the VSET instruction updates a vector state within the decode unit.

The infographic 300 includes replacing with micro-operations 340. In exemplary implementations, vector instructions can be replaced with one or more micro-operations such as vector micro-operations. The micro-operations can be based on a vector state within the decode unit at the time the micro-operations are generated. The vector state can include previously described parameters such as VL, VMUL, and so on. The vector micro-operations can be sent to specific instruction queues for further processing by the processor core. Embodiments include decoding, by the decode unit, a vector instruction. Further embodiments include replacing, by the decode unit, the vector instruction with one or more vector micro-operations, wherein the replacing is based on the immediate value that was included in the VSET instruction.

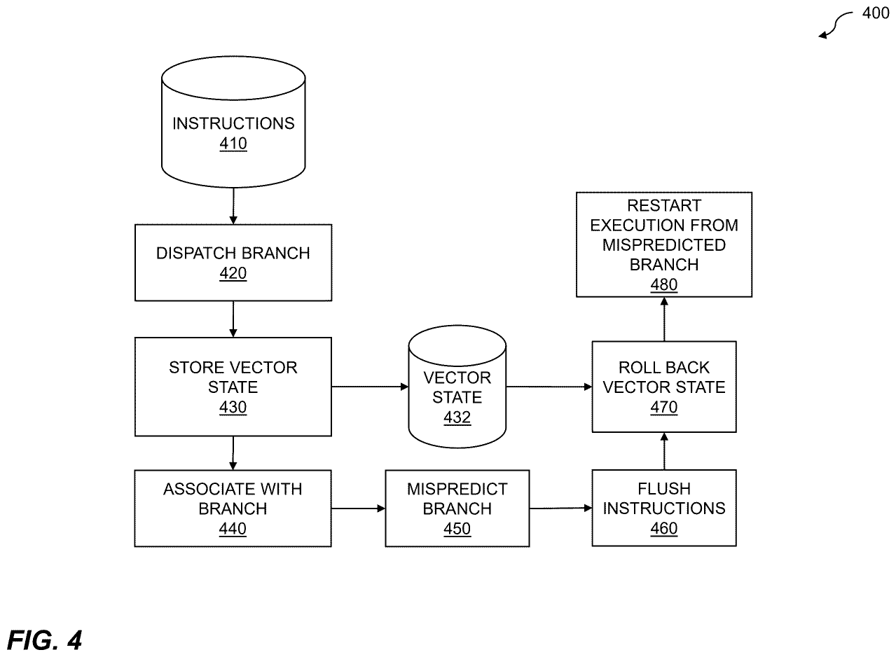

FIG. 4 is a second infographic for non-flushing vector micro-operations with VSET and a conditional branch. The infographic 400 includes instructions 410. The instructions can include a variety of instructions, including arithmetic instructions, memory management instructions, comparison instructions, branching instructions, scalar instructions, vector instructions, branching instructions, and so on. The instructions can include instructions that are replaced with multiple micro-operations for execution. The instructions can include VSET instructions. Some VSET instructions can include immediate values for operands. Immediate values can reduce the need for extra memory accesses, which can be slower than accessing data directly from the instruction itself. Moreover, the decode unit may not have access to general-purpose register (GPR) register files. Accordingly, for VSET instructions, using immediate values allows the decode unit to access the vector architectural state quickly and completely, thereby enabling the vector architectural state to be saved whenever it changes, and/or whenever a branch path is speculatively executed.

The infographic 400 includes dispatching a branch instruction 420. The branch instruction can be a conditional branch instruction. The branch instruction can cause speculative execution of instructions via a branch prediction algorithm. The speculation can continue as the branch is executed. Once the branch target address is determined, the processor core can determine if the speculatively executed instructions were correct or incorrect.

The infographic 400 includes storing a vector state 430. The vector state can be stored in a buffer 432. In exemplary implementations, a snapshot is taken in the decode stage whenever a VSET instruction is encountered. This snapshot can save the VSET state information. The saving can be based on a single entry history. A second VSET snapshot can be taken in the rename stage when a conditional branch is encountered. The depth of the second snapshot can depend on the number of active branches allowed by the processor core. In this way, a last known good vector architectural state is always available and associated with the conditional branch instruction. Saving the vector architectural state helps manage and optimize the use of computational resources and can reduce the overhead associated with recovering from a branch misprediction, allowing the processor to operate more effectively. Furthermore, by maintaining a saved vector state, the penalty for branch misprediction can be reduced, thereby improving overall processor performance. This performance improvement can accelerate many types of applications. In embodiments, the storing includes associating the vector state with the conditional branch instruction 440. In other embodiments, the associating is accomplished with an entry within a buffer. The buffer can comprise any memory element such as one or more flip-flops, one or more registers, a FIFO, a CAM, and so on.

The infographic 400 includes mispredicting the conditional branch 450. As described above and throughout, a branch misprediction can cause instructions to be incorrectly executed while the true target address of the branch instruction is determined. Once determined, the target address can be compared to the address given by the branch predictor. If those do not match, then the processor has executed erroneous instructions. The processor can initiate a recovery process to remove these instructions. However, the erroneous instructions can also include VSET instructions that can update the state in the decode unit. Thus, the state of the decode unit may also need to be repaired. Embodiments include mispredicting the conditional branch instruction, wherein the mispredicting causes one or more erroneous instructions to be executed, wherein the one or more erroneous instructions include erroneously changing the vector state within the decode unit. In some embodiments, the erroneously changing the vector state is based on a second VSET instruction, wherein the second VSET instruction is based on the mispredicting.

The infographic 400 includes flushing instructions 460. Recall that erroneous instructions can be executed by the processor core in response to a mispredicted branch instruction. The recovery process can include flushing the erroneous instructions from the processor core. Embodiments include flushing the one or more erroneous instructions. The infographic 400 includes rolling back the vector state 470. The rolling back of the vector state can include reverting the vector state to the last known good vector architectural state by retrieving the last known good vector architectural state from the buffer 432. By maintaining the last known good vector architectural state and reverting back to the last known good vector architectural state as part of a branch misprediction recovery process, it is possible to preserve instructions executed after the last known good vector architectural state, but before the mispredicted branch instruction, thereby reducing the number of instructions that may need to get flushed as a result of a branch misprediction and improving overall processor performance. Embodiments include rolling back the vector state to the vector state that was stored.

The infographic 400 includes restarting execution from the mispredicted branch 480. After the misprediction becomes known and incorrect instructions are flushed from the processor pipeline(s), the processor can restore the state to the point before the mispredicted branch. In addition to restoring the last known good vector architectural state, correct instructions can be fetched based on the correct branch target address, and execution can restart with instructions along the correct code path. This recovery process ensures that the execution gets back on track, albeit with some performance penalty (called a branch mispredict penalty) due to the flushing and re-execution steps. Disclosed implementations serve to reduce the performance penalty by reducing the number of instructions that need to be flushed and/or re-executed as a result of a branch misprediction event. Embodiments include restarting execution, wherein the restarting is based on the conditional branch instruction that was mispredicted.

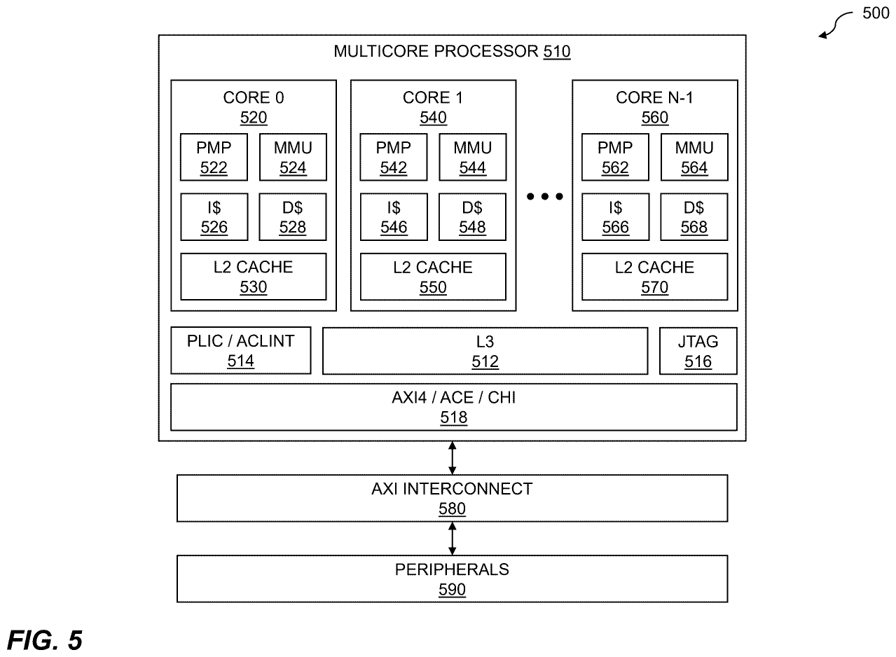

FIG. 5 is a block diagram of a multicore processor. The processor, such as a RISC-V™ processor, an ARM processor, or other suitable processor type, can include a variety of elements. The elements can include processor cores such as multiprocessor cores, one or more caches including local caches and shared caches, memory protection and management units, local storage, and so on. The elements of the multicore processor can further include one or more of a private cache; a test interface such as a joint test action group (JTAG) test interface; one or more interfaces to a network such as a network-on-chip, shared memory, and peripherals; and the like.

In the block diagram 500, the multicore processor 510 can comprise two or more processors, where the two or more processors can include homogeneous processors, heterogeneous processors, etc. In the block diagram, the multicore processor can include N processor cores such as core 0 520, core 1 540, core N-1 560, and so on. Each processor can comprise one or more elements. In one or more implementations, each core, including cores 0 through core N-1, can include a physical memory protection (PMP) element, such as PMP 522 for core 0; PMP 542 for core 1, and PMP 562 for core N-1. In a processor architecture such as the RISC-V™ architecture, a PMP can enable processor firmware to specify one or more regions of physical memory such as cache memory of the shared memory, and to control permissions to access the regions of physical memory. The cores can include a memory management unit (MMU) such as MMU 524 for core 0, MMU 544 for core 1, and MMU 564 for core N-1. The memory management units can translate virtual addresses used by software running on the cores to physical memory addresses with caches, the shared memory system, etc.

The processor cores associated with the multicore processor 510 can include caches such as instruction caches and data caches. The caches, which can comprise level 1 (L1) caches, can include an amount of storage such as 16 KB, 32 KB, and so on. The caches can include an instruction cache I$ 526 and a data cache D$ 528 associated with core 0; an instruction cache I$ 546 and a data cache D$ 548 associated with core 1; and an instruction cache I$ 566 and a data cache D$ 568 associated with core N-1. In addition to the level 1 instruction and data caches, each core can include a level 2 (L2) cache. The level 2 caches can include L2 cache 530 associated with core 0; L2 cache 550 associated with core 1; and L2 cache 570 associated with core N-1. The cores associated with the multicore processor 510 can include further components or elements. The further elements can include a level 3 (L3) cache 512. The level 3 cache, which can be larger than the level 1 instruction and data caches, and the level 2 caches associated with each core, can be shared among all of the cores. The further elements can be shared among the cores. In one or more implementations, the further elements can include a platform level interrupt controller (PLIC) 514. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 516. The JTAG can provide a boundary within the cores of the multicore processor. The JTAG can enable fault information to a high precision. The high-precision fault information can be critical to rapid fault detection and repair.

The multicore processor 510 can include one or more interface elements 518. The interface elements can support standard processor interfaces including an Advanced eXtensible Interface (AXI™) such as AXI4™, an ARM™ Advanced eXtensible Interface (AXI™) Coherence Extensions (ACE™) interface, an Advanced Microcontroller Bus Architecture (AMBA™) Coherence Hub Interface (CHI™), etc. In the block diagram 500, the interface elements can be coupled to the interconnect. The interconnect can include a bus, a network, and so on. The interconnect can include an AXI™ interconnect 580. In one or more implementations, the network can include network-on-chip functionality. The AXI™ interconnect can be used to connect memory-mapped “master” or boss devices to one or more “slave” or worker devices. In the block diagram 500, the AXI interconnect can provide connectivity between the multicore processor 510 and one or more peripherals 590. The one or more peripherals can include storage devices, networking devices, and so on. The peripherals can enable communication using the AXI™ interconnect by supporting standards such as AMBA™ version 4, among other standards.

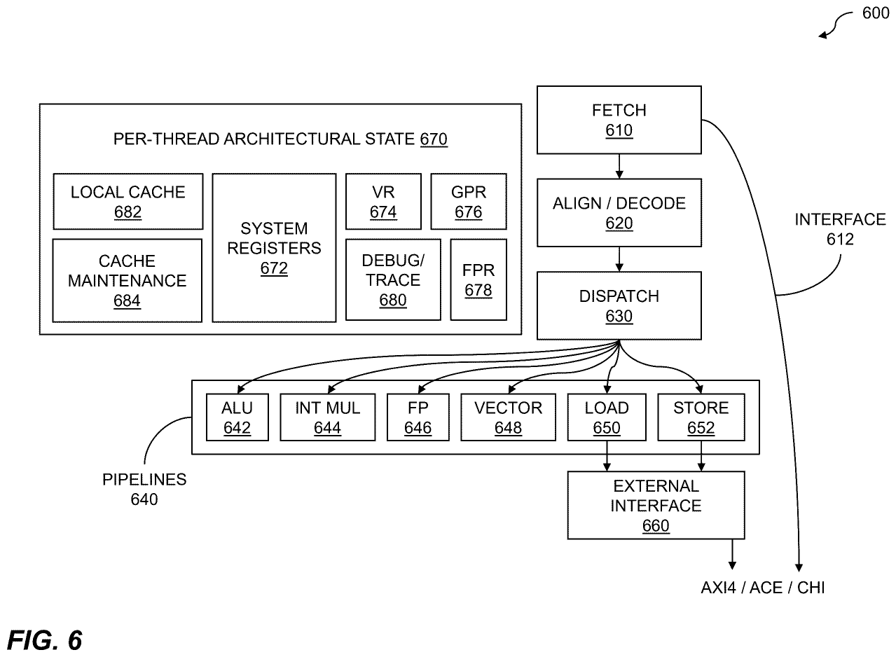

FIG. 6 is a block diagram of a pipeline. One or more pipelines associated with a processor architecture can be used to greatly enhance processing throughput. The processor architecture can be associated with one or more processor cores. The processing throughput can be increased because multiple operations can be executed in parallel. In one or more implementations, a processor core is accessed. The processor core is coupled to a memory hierarchy, and the processor core is configured to execute vector operations, scalar operations, and various micro-operations that implement architectural instructions.

The blocks within the block diagram can be configurable in order to provide varying processing levels. The varying processing levels can be based on processing speed, bit lengths, word lengths, numbers of micro-operations, and so on. The block diagram 600 can include a fetch block 610. The fetch block 610 can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 612. The interface can include a standard interface such as one or more industry standard interfaces. The interfaces can include an Advanced eXtensible Interface (AXI™), an ARM™ Advanced eXtensible Interface (AXI™) Coherence Extensions (ACE™) interface, an Advanced Microcontroller Bus Architecture (AMBA™) Coherence Hub Interface (CHI™), etc.

The block diagram 600 includes an align and decode block 620. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decoded packets. The decoded packets can be used in the pipeline to manage execution of operations. The block diagram 600 can include a dispatch block 630. The dispatch block can receive decoded instruction packets from the align and decode block. The decoded instruction packets can be used to control a pipeline 640, where the pipeline can include an in-order pipeline, an out-of-order (OoO) pipeline, etc. In one or more exemplary implementations, the processor core executes one or more instructions out of order. A pipeline can be associated with the one or more execution units. The pipelines associated with the execution units can include processor cores, arithmetic logic unit (ALU) pipelines 642, integer multiplier pipelines 644, floating-point unit (FPU) pipelines 646, vector unit (VU) pipelines 648, and so on. The dispatch unit can further dispatch instructions to pipelines that can include load pipelines 650, and store pipelines 652. The load pipelines and the store pipelines can access storage such as the common memory using an external interface 660. The external interface can be based on one or more interface standards such as the Advanced eXtensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In one or more exemplary implementations, the plurality of processors can be configured to support multi-threading. The system block diagram can include a per-thread architectural state block 670. The inclusion of the per-thread architectural state can be based on a configuration or architecture that can support multi-threading. In one or more exemplary implementations, thread selection logic can be included in the fetch and dispatch blocks discussed above. The per-thread architectural state can include system registers 672. The system registers can be associated with individual processors, a system comprising multiple processors, and so on. The system registers can include exception and interrupt components, counters, etc. The per-thread architectural state can include further registers such as vector registers (VRs) 674. The vector registers can be grouped in a vector register file and can be used for vector operations. In one or more exemplary implementations, the width of the vector register file is 512 bits. Additional registers, such as general-purpose registers (GPRs) 676 and floating-point registers (FPRs) 678, can be included. These registers can be used for general purpose (e.g., integer) operations and floating-point operations, respectively. The per-thread architectural state can include a debug and trace block 680. The debug and trace block can enable debug and trace operations to support code development, troubleshooting, and so on. In one or more exemplary implementations, an external debugger can communicate with a processor through a debugging interface such as a joint test action group (JTAG) interface. The per-thread architectural state can include a local cache state 682. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 684. The cache maintenance state can include maintenance needed, maintenance pending, and maintenance complete states, etc.

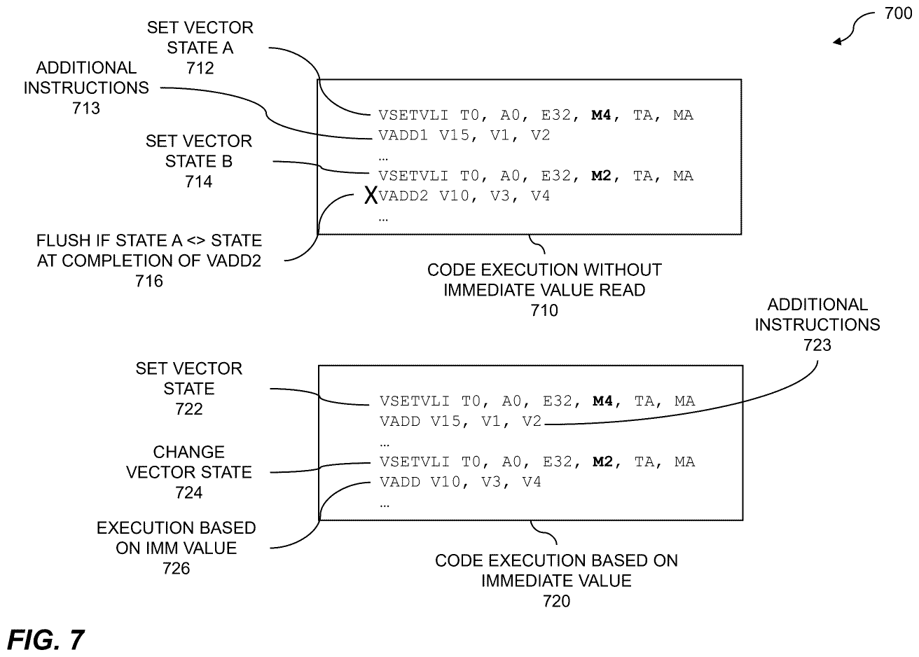

FIG. 7 is a first code example of non-flushing vector micro-operations with VSET. The example 700 includes code executed without features of disclosed implementations, indicated at 710. A first VSET instruction, indicated at 712, sets a first architectural state using immediate values. In particular, the instruction indicated at 712 is a VSETVLI instruction using immediate operands. The VSETVLI instruction in a RISC-V processor is part of the RISC-V™ Vector Extension (RVV) and can be used to configure the vector processing unit. It can set the vector length (VL), the vector register group multiplier (LMUL), and other parameters for subsequent vector operations. The code example includes additional instructions following the first VSET instruction, indicated at 713. The code then includes a second VSET instruction, indicated at 714. As can be seen in the example, the second VSET instruction 714 uses a different immediate operand “M2” as compared with operand “M4” in instruction 712, thus changing the vector state. The code further includes instruction 716 following the second VSET instruction. Without the disclosed embodiments, the immediate value is not updated within the decode unit. Since the change in architectural state is not detected at the decode stage of instruction 716, the instruction 716 can be replaced with one or more vector micro-operations using the incorrect architectural state. Thus, these vector micro-operations can be incorrectly executed, and must be flushed later (indicated by an “X”) once the architectural state mismatch is detected at a later pipeline stage.

The same code is shown at 720, indicating execution results using disclosed embodiments. A first VSET instruction, indicated at 722, sets a first architectural state using immediate values. The code example includes additional instructions following the first VSET instruction, indicated at 723. The code then includes a second VSET instruction, indicated at 724. As can be seen in the example, the second VSET instruction 724 uses a different immediate operand “M2” as compared with operand “M4” in instruction 722. The code further includes instruction 726 following the second VSET instruction. With the features of disclosed embodiments, the change in architectural state is detected at the decode stage of instruction 716 and the vector state within the decode unit is updated. Thus, the vector instruction 716 can be replaced with one or more vector micro-operations using the correct architectural state and does not need to be flushed at a subsequent stage, thereby improving overall processor performance.

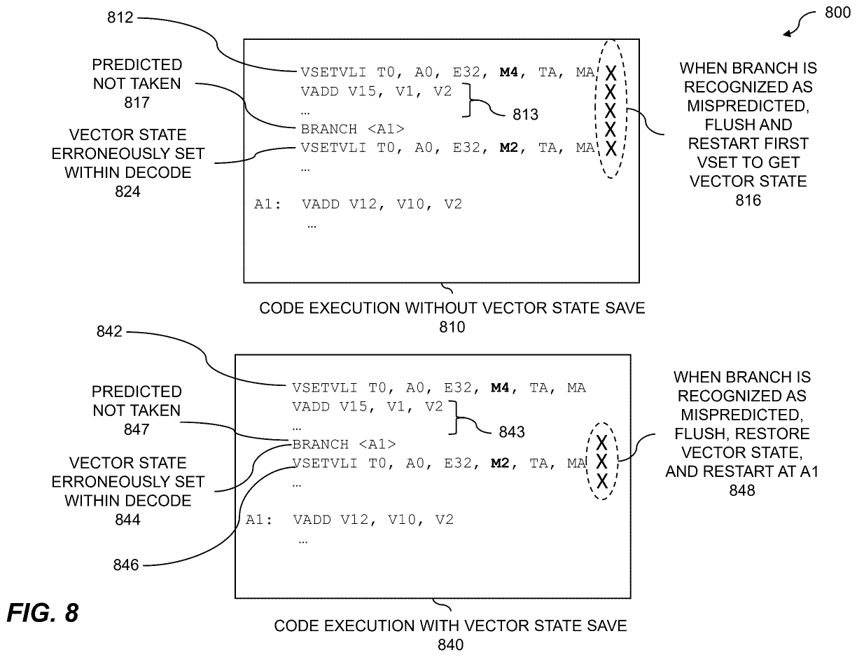

FIG. 8 is a second code example of non-flushing vector micro-operations with a conditional branch. The example 800 includes code executed without features of disclosed implementations, indicated at 810. A first VSET instruction, indicated at 812, sets a first architectural state using immediate values. In particular, the instruction indicated at 812 is a VSETVLI instruction using immediate operands. The VSETVLI instruction in a RISC-V™ processor is part of the RISC-V™ Vector Extension (RVV) and can be used to configure the vector processing unit. It can set the vector length (VL), the vector register group multiplier (LMUL), and other parameters for subsequent vector operations. The code example includes additional instructions following the first VSET instruction, indicated at 813. The code then includes a conditional branch instruction 817 which is incorrectly predicted as not taken. Accordingly, sequential code is speculatively executed. The next instruction is a second VSET instruction, indicated at 824. As can be seen in the example, the second VSET instruction 824 uses a different immediate operand “M2” as compared with operand “M4” in instruction 812, thus changing the vector state. Once the branch instruction 817 is determined to be mispredicted, the vector state needs to be restored to its last known good state. This involves flushing all the instructions as indicated by an “X” as referred to at 816. The flushing includes flushing additional instructions 813. In practice, there can be multiple additional instructions, based on the depth of the instruction pipeline. The additional instructions need to be re-executed starting at the first VSETVLI (which was not executed speculatively) in order to reset the correct vector state. The flushing and restarting of instructions starting at the last time the vector state was set non-speculatively can have an adverse effect on processor performance. When the branch instruction is encountered the second time, code execution can now properly follow the taken path at A1.

The same code is shown at 840, indicating execution results using disclosed implementations. A first VSET instruction, indicated at 842, sets a first architectural state using immediate values. In particular, the instruction indicated at 842 is a VSETVLI instruction using immediate operands. The code example includes additional instructions following the first VSET instruction, indicated at 843. The code then includes a conditional branch instruction 847 which is incorrectly predicted as not taken. With disclosed implementations, prior to executing the branch instruction and associated code path, the last known good vector architectural state is stored in a buffer 844. The next code that is speculatively executed is a second VSET instruction, indicated at 846. As can be seen in the example, the second VSET instruction 846 uses a different immediate operand “M2” as compared with operand “M4” in instruction 842, thus changing the vector state. Once the branch instruction is determined to be mispredicted, the vector state needs to be restored to its last known good state. Unlike the scenario described with code 810, in this case, the branch misprediction recovery process only flushes the instructions up to the branch instruction 847, as indicated by an “‘X’” as referred to at 848, since the last known good vector architectural state was saved prior to speculatively executing branch instruction. Thus, the flushing does not include flushing additional instructions 843 and re-executing the first VSETVLI instruction as in the previous example. In practice, there can be multiple additional instructions, based on the depth of the instruction pipeline. By reducing the number of instructions that need to be flushed and eliminating the need to re-execute back to a previous VSET instruction, disclosed embodiments can provide improved processor performance.

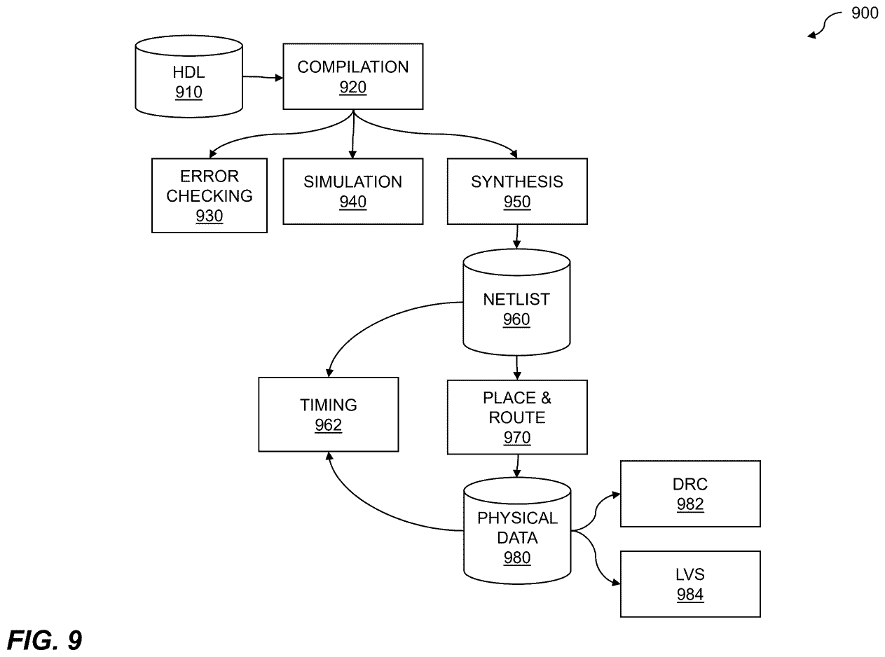

FIG. 9 is a design flow for semiconductor logic generation. The design flow can be based on one or more design automation tools and can include instructions and/or functions for design, generation of semiconductor logic for, and implementation of integrated circuits that support non-flushing vector micro-operations with VSET. The design flow 900 can include instructions and/or functions for generation and/or manipulation of design data such as hardware description language (HDL) constructs for specifying structure and operation of an integrated circuit. The design flow 900 can further perform operations to generate and manipulate Register Level Transfer (RTL) abstractions. These abstractions can include parameterized inputs that enable specifying elements of a design such as a number of elements, sizes of various bit fields, sizes of caches, number of registers, enablement of certain features (such as architectural extensions), and so on. The parameterized inputs can be used as inputs to a logic synthesis process which can create semiconductor logic that implements the gate-level abstraction of the HDL. The gate level data can be further processed and used for fabrication of integrated circuit (IC) devices.

Modern integrated circuit designs are typically created using complex software design automation tools. The design flow 900 includes a hardware description language (HDL) 910 of a logic design. The HDL can enable a human to create and test a description of a logic function, logic block, system, etc. they want to design by describing the system using code. Any HDL can be used including Verilog™, VHDL, SystemC, Chisel, and other languages. The code can describe the system at various levels of abstraction. The levels of abstraction can include a high level of abstraction that describes the behavior of the system, at a register transfer level (RTL), which describes the design based on the transfer of data between registers, at a gate level description which names the particular circuits used and the interconnections between them, and so on. For example, a high level behavioral description may describe multiplication as C=A*B. An RTL level may describe loading data into register A, loading data into register B, performing a multiplication operation, and storing the product of A and B in register C. A circuit level description may name the particular circuits to use and the interconnections among them. At the RTL stage, disclosed implementations can capture both functional behavior and timing relationships. While the behavioral description can be the most user friendly, the RTL description can enable more control over how the design is implemented. Common text file formats, such as “.v”, “.vhd”, are typically used for the HDL source code in the semiconductor design flow.

The HDL source code can be compiled 920. The compilation can comprise one or more analysis, parsing, and/or elaboration steps. The compilation can result in an executable model of the HDL source code, which can be suitable for further steps of design automation. The executable model can be hierarchical. The compilation process can include error checking 930. The error checking can include syntactical checking; semantic checking; checking of references to other referenced libraries, designs, and models; etc. One or more implementations may include automated linting tools that detect undeclared signals, mismatched bit widths, or unused variables in HDL code.

One or more implementations may include simulation 940 of the HDL or RTL code prior to synthesis. Simulation environments can enable verification of design parameters such as functional correctness, timing behavior, and corner cases. By running testbenches against the HDL code, designers can confirm that arbitration logic operates as intended before committing to gate level synthesis. Simulation can also provide visibility into signal waveforms and processor request interactions, ensuring that arbitration criteria are correctly enforced. One or more implementations may also address conflicts that arise in visualization and reporting. For example, waveform viewers and schematic generators may use color coding to distinguish signals, buses, and states. Conflicts in color assignments or overlapping graphical elements can obscure analysis. Tools therefore include configurable color palettes and conflict resolution mechanisms to ensure clarity in simulation results and design documentation.

Synthesis 950 tools can be used to map the abstract operations captured by the HDL code into logic gates, flip-flops, cache structures, interconnect structures, etc. This process can enable automated generation of semiconductor logic that can be implemented in silicon, while preserving the intended arbitration and control functions originally specified. The synthesis can produce a gate level netlist 960 that represents the actual semiconductor logic structures such as described above. The netlist can be a technology-mapped netlist (e.g., mapped to a specific semiconductor fabrication technology). Synthesized netlists may be represented in formats such as EDIF, Liberty, and so on. In some implementations, checking can be performed to ensure that the logic generated by the synthesis tool is equivalent to the logic defined by the HDL source code. This can be accomplished by one or more testbenches, running one or more tests on larger blocks of logic and comparing those to the synthesized circuits, performing formal verification to prove logical equivalence between HDL and the netlist, and so on. Timing 962 can be performed on the netlist. The timing can generate an initial view including critical paths and/or paths that should be retimed with different synthesis directions. The timing information can be generated from established models of semiconductor devices, gates, etc. that have been selected by the synthesis tool. Estimates for wiring delays can also be included in the timing data.

The gate level netlist can be placed and routed 970 to produce physical data 980 which represents layout suitable for fabrication. Examples of place and route tools are Cadence Innovus™, Synopsis IC complier™, versatile place and route (VPR), nextpnr, and others. Layout data is often exchanged in GDSII or OASIS formats. These standardized formats enable interoperability across tools and vendors, and support error checking during import/export. Timing 962 can again be run on the placed and routed design to ensure that the design meets cycle time requirements taking into account more accurate wire lengths, parasitics, clock domains, and so on. Design rule checks (DRC) 982 and layout versus schematic (LVS) 984 checks can confirm that the generated semiconductor logic adheres to fabrication constraints and matches the intended design. This tool-based flow demonstrates how software code can be transformed into concrete semiconductor logic structures, providing enabling support for claims directed to logic generation.

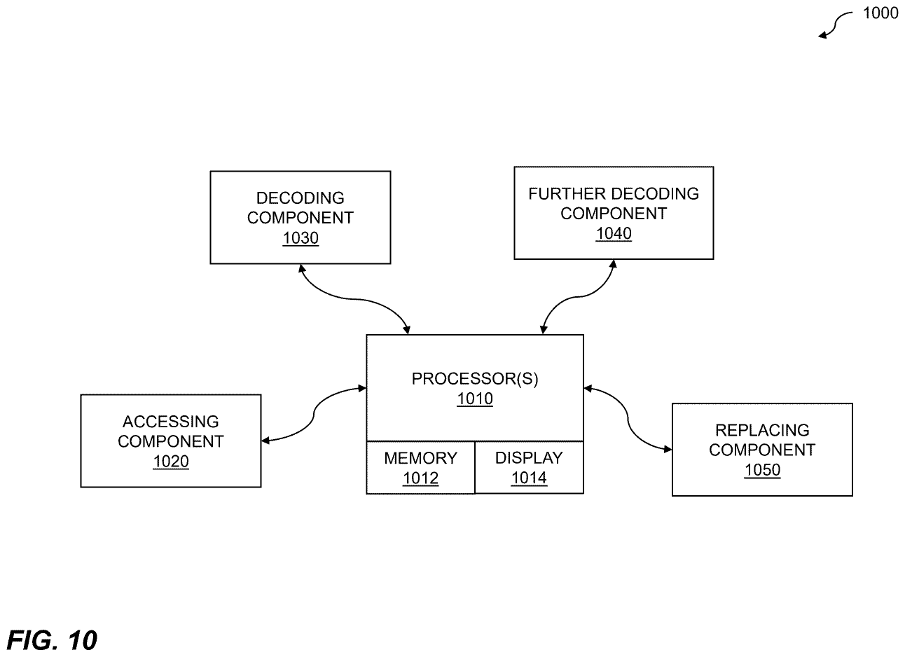

FIG. 10 is a system diagram for non-flushing vector micro-operations with VSET. The system 1000 can include instructions and/or functions for design, generation of semiconductor logic for, and implementation of integrated circuits that support non-flushing vector micro-operations with VSET. The system 1000 can include instructions and/or functions for generation and/or manipulation of design data, such as hardware description language (HDL) constructs, for specifying structure and operation of an integrated circuit. The system 1000 can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

The system can include one or more of processors, memories, cache memories, displays, and so on. The system 1000 can include one or more processors 1010. The processors can include standalone processors, processors within integrated circuits or chips, processor cores in FPGAs or ASICs, and so on. The one or more processors 1010 are coupled to a memory 1012, which stores instructions. The memory can include one or more of local memory, cache memory, system memory, etc. The system 1000 can further include a display 1014 coupled to the one or more processors 1010. The display 1014 can be used for displaying data, instructions, operations, micro-operations, VSET operations, and the like. The operations can include instructions and functions for implementation of integrated circuits, including processor cores. In exemplary implementations, the processor cores can include RISC-V™ processor cores. A system comprising the one or more processors 1010, when executing the instructions which are stored in the memory 1012, is configured to enable non-flushing vector micro-operations with VSET. The system 1000 can include a computer system for instruction execution comprising: a memory which stores instructions; one or more processors coupled to the memory, wherein the one or more processors, when executing the instructions which are stored, are configured to:
access a processor core, wherein the processor core is configured to execute vector instructions and micro-operations; decode, by a decode unit, a vector set (VSET) instruction, wherein the VSET instruction includes an immediate value, and wherein the VSET instruction updates a vector state within the decode unit; further decode, by the decode unit, a vector instruction; and
replace, by the decode unit, the vector instruction with one or more vector micro-operations, wherein the replacing is based on the immediate value that was included in the VSET instruction.

The system 1000 can include an accessing component 1020. The accessing component 1020 can include functions and instructions for accessing a processor core, wherein the processor core is coupled to a memory hierarchy, and wherein the processor core is configured to execute vector operations, scalar operations, and micro-operations. The processor core can include an ARM™ core, a MIPS™ core, and/or other suitable core type. In one or more exemplary implementations, the processor core can include a RISC-V™ architecture. The processor core can be configured to execute vector instructions and micro-operations. The RISC-V architecture can include extensions, where the extensions can enable execution of various arithmetic and logic operations. In exemplary implementations, a RISC-V™ architecture can include vector extensions.

The system 1000 can include a decoding component 1030. The decoding component 1030 can include functions and instructions for decoding, by a decode unit, a vector set (VSET) instruction, wherein the VSET instruction includes an immediate value, and wherein the VSET instruction updates a vector state within the decode unit. A VSET instruction in a RISC-V™ processor can be part of a RISC-V™ Vector Extension (RVV) that configures a vector processing unit which can be included within the processor core. This instruction can be used to set various parameters of the vector architectural state, enabling efficient execution of vectorized computations. The VSET instruction can update a vector state directly with an immediate value, indirectly by a set of registers, using a combination of both, or in other ways. When registers are used to set a vector state, a micro-operation sequencer within the decode unit can produce unreliable results. One or more immediate values can be included as operands in a VSET instruction. The decode unit can read the immediate values, set a vector state, and/or generate correct micro-operations.

The system 1000 can include a further decoding component 1040. The further decoding component 1040 can include functions and instructions for further decoding, by the decode unit, a vector instruction. The vector instruction can be decoded before, during, or after the updating of the vector state. The vector instruction can include arithmetic operations such as vector addition (VADD), vector subtraction (VSUB), vector multiplication (VMUL), and/or vector division (VDIV). The vector instruction can include logical operations such as bitwise AND (VAND), bitwise OR (VOR), bitwise XOR (VXOR), and bitwise NOT (VNOT). The vector instructions can include comparison operations such as VMSLT, VMSLE, and/or VMSEQ for setting a bit based on a comparison result. The vector instruction can include data movement operations such as vector load (VL) and/or vector store (VS). Other vector instructions are possible in exemplary implementations.

The system 1000 can include a replacing component 1050. The replacing component 1050 can include functions and instructions for replacing, by the decode unit, the vector instruction with one or more vector micro-operations, wherein the replacing is based on the immediate value that was included in the VSET instruction. The vector micro-operations can include a series of less complex instructions that can take the place of a single, more complex instruction. In embodiments, the replacing is accomplished by a micro-operation sequencer. The micro-operation sequencer can be used for vector instructions, scalar instructions, floating-point instructions, and so on. The use of micro-operations, along with dedicated queues, can reduce bottlenecks such as pipeline stalls, thereby improving processor performance. In exemplary implementations, the micro-operation sequencer can be implemented as a finite state machine, which takes inputs that can include a type register, a source register, a destination register, and/or other operands.

The system 1000 can include a computer program product embodied in a non-transitory computer readable medium for instruction execution, the computer program product comprising code which causes one or more processors to generate semiconductor logic for:
accessing a processor core, wherein the processor core is configured to execute vector instructions and micro-operations; decoding, by a decode unit, a vector set (VSET) instruction, wherein the VSET instruction includes an immediate value, and wherein the VSET instruction updates a vector state within the decode unit; further decoding, by the decode unit, a vector instruction; and replacing, by the decode unit, the vector instruction with one or more vector micro-operations, wherein the replacing is based on the immediate value that was included in the VSET instruction.

As can now be appreciated, disclosed implementations provide processor functionality that includes saving off a vector architectural state prior to speculatively executing instructions, offering several advantages, especially when it comes to handling branch mispredictions. The advantages can include reduced pipeline flushes. By saving the vector architectural state before speculative execution, disclosed implementations can more efficiently handle branch mispredictions. Instead of flushing the entire pipeline and restarting from a previous instruction that set a vector state, the processor only needs to revert to the saved state and flush only those instructions which were improperly executed due to the branch misprediction. Minimizing pipeline flushes and instruction re-execution means less downtime for the processor. Fewer pipeline disruptions lead to better utilization of processor resources, resulting in improved overall performance. Furthermore, disclosed implementations can enable enhanced speculative execution. With a saved vector architectural state, the processor can more aggressively speculate on branches since the processor can quickly recover if a misprediction occurs. This feature can enable higher instruction throughput and better performance in predictive scenarios. Thus, disclosed implementations improve the ability of a processor to handle branch mispredictions with minimal performance impact, leading to smoother and more efficient operation.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or processor-implemented methods and/or computer-implemented methods. Any and all such functions—generally referred to herein as a “circuit,” “module,” or “system” may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for instruction execution comprising:
accessing a processor core, wherein the processor core is configured to execute vector instructions and micro-operations;
decoding, by a decode unit, a vector set (VSET) instruction, wherein the VSET instruction includes an immediate value, and wherein the VSET instruction updates a vector state within the decode unit;
further decoding, by the decode unit, a vector instruction; and
replacing, by the decode unit, the vector instruction with one or more vector micro-operations, wherein the replacing is based on the immediate value that was included in the VSET instruction.

2. The method of claim 1 further comprising dispatching, by the processor core, a conditional branch instruction.

3. The method of claim 2 wherein the dispatching includes storing, by the decode unit, the vector state within the decode unit.

4. The method of claim 3 further comprising mispredicting the conditional branch instruction.

5. The method of claim 4 wherein the mispredicting causes one or more erroneous instructions to be executed.

6. The method of claim 5 wherein the one or more erroneous instructions include erroneously changing the vector state within the decode unit.

7. The method of claim 6 wherein the erroneously changing the vector state is based on a second VSET instruction.

8. The method of claim 7 wherein the second VSET instruction is based on the mispredicting.

9. The method of claim 8 further comprising rolling back the vector state to the vector state that was stored.

10. The method of claim 9 further comprising flushing the one or more erroneous instructions.

11. The method of claim 10 further comprising restarting execution, wherein the restarting is based on the conditional branch instruction that was mispredicted.

12. The method of claim 3 wherein the storing includes associating the vector state with the conditional branch instruction.

13. The method of claim 12 wherein the associating is accomplished with an entry within a buffer.

14. The method of claim 13 further comprising stalling, by the decode unit, wherein the buffer is full.

15. The method of claim 13 further comprising releasing the entry within the buffer.

16. The method of claim 15 wherein the releasing is based on rolling back the vector state to the vector state that was stored.

17. The method of claim 15 wherein the releasing is based on a correct branch prediction.

18. The method of claim 1 wherein the replacing is accomplished by a micro-operation sequencer.

19. A computer program product embodied in a non-transitory computer readable medium for instruction execution, the computer program product comprising code which causes one or more processors to generate semiconductor logic for:
accessing a processor core, wherein the processor core is configured to execute vector instructions and micro-operations;
decoding, by a decode unit, a vector set (VSET) instruction, wherein the VSET instruction includes an immediate value, and wherein the VSET instruction updates a vector state within the decode unit;
further decoding, by the decode unit, a vector instruction; and
replacing, by the decode unit, the vector instruction with one or more vector micro-operations, wherein the replacing is based on the immediate value that was included in the VSET instruction.

20. A computer system for instruction execution comprising:
a memory which stores instructions;
one or more processors coupled to the memory wherein the one or more processors, when executing the instructions which are stored, are configured to:
access a processor core, wherein the processor core is configured to execute vector instructions and micro-operations;
decode, by a decode unit, a vector set (VSET) instruction, wherein the VSET instruction includes an immediate value, and wherein the VSET instruction updates a vector state within the decode unit;
further decode, by the decode unit, a vector instruction; and
replace, by the decode unit, the vector instruction with one or more vector micro-operations, wherein the replacing is based on the immediate value that was included in the VSET instruction.
